(19) United States
(12) Patent Application Publication
(10) Pub. No.: US 2014/0115601 A1
(43) Pub. Date: Apr. 24, 2014

(54) DATA PROCESSING METHOD AND DATA PROCESSING SYSTEM

(71) Applicant: FUJITSU LIMITED, Kawasaki-shi (JP)

(72) Inventors: Takahisa SUZUKI, Yokohama (JP); Koichiro YAMASHITA, Hachioji (JP); Hiromasa YAMAUCHI, Usakos (NA); Koji KURIHARA, Kawasaki (JP); Toshiya OTOMO, Kawasaki (JP); Naoki ODATE, Akiruno (JP)

(73) Assignee: FUJITSU LIMITED, Kawasaki-shi (JP)

(21) Appl. No.: 14/136,001

(22) Filed: Dec. 20, 2013

Related U.S. Application Data
(63) Continuation of application No. PCT/JP2011/064842, filed on Jun. 28, 2011.

(51) Int. Cl. G06F 9/50

(52) U.S. Cl. CPC G06F 9/5016
USPC 718/104

(57) ABSTRACT

A data processing method that is executed by a processor includes determining based on a size of an available area of a first memory whether first data of a first thread executed by a first data processing apparatus among a plurality of data processing apparatuses is transferable to a first memory; transferring second data that is of a second thread and stored in the first memory to second memory, when at the determining, the first data is determined to not be transferrable; and transferring the first data to the first memory.

### CROSS REFERENCE TO RELATED APPLICATIONS

This application is a continuation application of International Application PCT/JP2011/064842, filed on Jun. 28, 2011 and designating the U.S., the entire contents of which are incorporated herein by reference.

### FIELD

The embodiments discussed herein are related to a data processing method and a data processing system that perform data migration related to thread migration among plural processors.

### BACKGROUND

A technique has been disclosed that increases data access efficiency by employing high-speed, small-capacity work memory in addition to ordinary memory and cache, where data that is not suitable for caching, such as temporarily-used data and stream data, is placed in the work memory data (see, e.g., Japanese Laid-Open Patent Publication Nos. 2005-56401, H11-65989, and H7-271659).

When work memory is employed in a multi-core processor, work memory is generally provided for each processor to maintain high-speed performance. In the multi-core processor, a thread running on a processor may be moved to another processor to balance the load among processors. In this case, if the thread to be moved continues to use the work memory, the thread cannot be moved. Hence, there is a technique that allows a thread to refer to a work memory of another processor so that when the thread is moved, the thread can directly refer to the work memory of the original processor, thereby enabling transfer of the thread that is using the work memory (see, e.g., Japanese Laid-Open Patent Publication No. 2009-199414).

With the conventional techniques above, however, the work memory of another processor is physically remote and consequently, attempts to refer to the work memory results in increased access delay and reduced thread throughput as compared to referring to the work memory of the host processor. An attempt to move data in work memory used by a thread together with a transfer of the thread requires processing and time (costs). Furthermore, if another thread on a destination processor uses the work memory of the destination processor, area management of the work memory is needed, making processing complicated.

### SUMMARY

According to an aspect of an embodiment, a data processing method that is executed by a processor includes determining based on a size of an available area of a first memory whether first data of a first thread executed by a first data processing apparatus among a plurality of data processing apparatuses is transferable to a first memory; transferring second data that is of a second thread and stored in the first memory to second memory, when at the determining, the first data is determined to not be transferrable; and transferring the first data to the first memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic view for explaining functions of a data processing apparatus according to an embodiment;

FIG. 2 is a flowchart of an example of data processing according to the embodiment;

FIG. 3 is a block diagram of a hardware configuration of the data processing apparatus according to a first embodiment;

FIG. 4 is a block diagram of a software configuration of the data processing apparatus according to the first embodiment;

FIG. 5 is a chart of information concerning an execution object;

FIG. 6 is a chart of translation between a logical address and a physical address;

FIG. 7 is a chart of stack areas according to thread;

FIG. 8 is a chart of a stack area arrangement;

FIG. 9 is a diagram of a run queue implementation example;

FIG. 10 is a diagram of thread migration during load distribution processing;

FIG. 11 is a chart of work memory management by a work memory managing unit;

FIG. 12 is a chart of an example of work memory management information;

FIG. 13 is a flowchart of contents of processing for establishing stack areas;

FIG. 14 is a transition diagram of state transition of an area on work memory;

FIG. 15 is a flowchart of processing to establish a work memory area;

FIG. 16 is a flowchart of processing after completion of a DMA transfer;

FIG. 17 is a flowchart of processing at the time of switching execution threads;

FIG. 18 is a flowchart of area replacement processing;

FIG. 19 is a flowchart of load distribution processing;

FIG. 20 is a flowchart of processing to migrate work memory data;

FIG. 21 is a sequence diagram of processing timing of a system according to the first embodiment;

FIG. 22 is a chart indicating the arrangement of data areas according to a second embodiment; and

FIG. 23 is a diagram of an example of application to a system that employs the data processing apparatus depicted in FIGS. 3 and 4.

### DESCRIPTION OF EMBODIMENTS

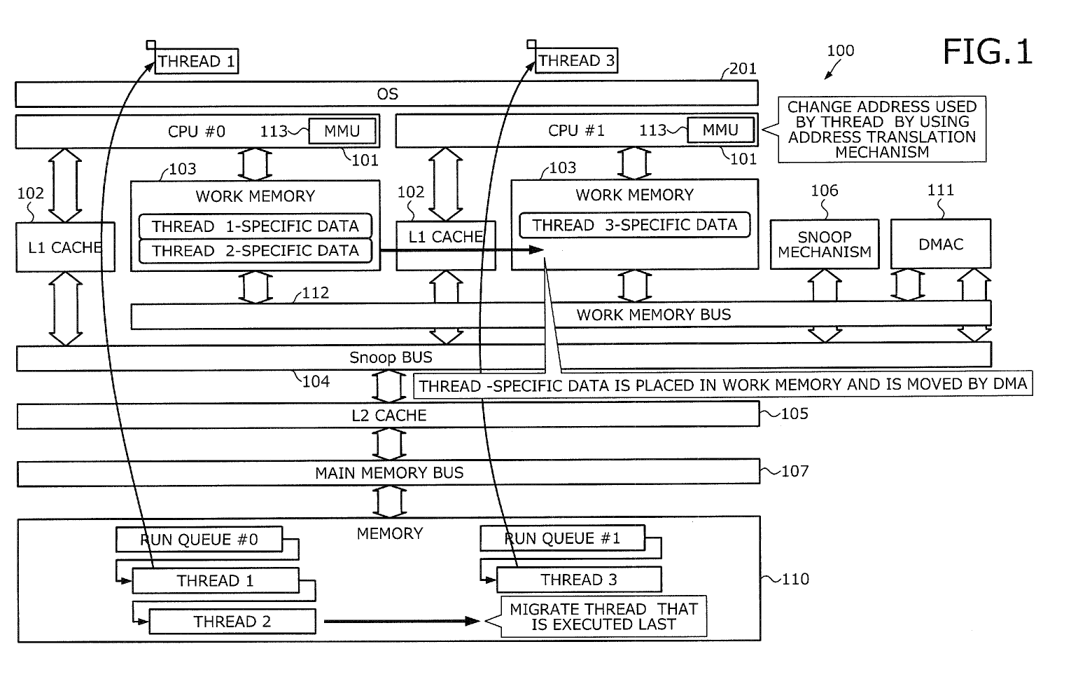

Embodiments of a data processing method and a data processing system will be described in detail with reference to the accompanying drawings. FIG. 1 is a schematic view for explaining functions of a data processing apparatus according to the embodiments. In the disclosed technique, a multi-core processor system includes plural processors 101 each having work memory (first memory) 103. The plural processors 101 share memory (second memory) 110.

A work memory managing unit (a memory managing unit) of an operating system (OS) places thread-specific data used by threads on the work memory 103 and, in conjunction with scheduler units 210 of the OS 201, migrates (transfers) the data on the work memory 103 to respective host processors 101 by utilizing a DMA transfer effected by a dynamic memory access controller (DMAC) 111 during the execution of other threads.

In the depicted example, when a first thread (Thread 1) is migrated from a heavily loaded first processor (CPU#0) 101 to a lightly loaded second processor (CPU#1) 101, a thread (Thread 2) that is executed last after migrating to the lightly loaded processor (CPU#1) 101 is determined as a thread to be migrated among threads allocated to the heavily loaded processor (CPU#0) 101. If the area required for the migration of a work memory are used by the thread (Thread 2) subject to migration is available in the work memory 103 of the destination processor (CPU#1) 101, thread-specific data (first data) is migrated to the work memory 103 of the destination processor (CPU#1) 101 via the DMAC 111.

Although not depicted in FIG. 1, a case is also supported where the required area is not available in the work memory 103 of the destination second processor (CPU#1) 101. In this case, if the destination second processor (CPU#1) 101 has a work memory area that is used by a third thread (Thread 3) that is executed after the thread (Thread 2) to be moved, thread-specific data of the third thread (Thread 3) is migrated (pushed out) to the memory 110 by the DMAC 111.

If the required area is established on the work memory 103, thread-specific data used by the thread (Thread 2) to be migrated is migrated to the work memory 103 of the destination processor (CPU#1) 101 via the DMAC 111. If the required area cannot be established, however, the thread-specific data on the work memory 103 used by the thread (Thread 2) to be migrated is temporarily migrated to the memory 110. In this case, data on the work memory 103 is replaced when switching the threads executed by the scheduler units 210.

The disclosed technique mainly executes the data processing below.

1. In a multi-core processor system that has work memory 103 for each of the processors 101 and the DMAC 111 that is DMA-accessible to each work memory 103 and to the memory 110, replacement of work memory 103 data is performed by the DMA, in conjunction with the scheduler units 210 of the OS 201.
2. Data used by a given thread alone is placed on the work memory 103 such that data of a thread that is scheduled, by the OS scheduler, to be executed before the given thread is preferentially placed on the work memory 103.
3. When the thread to be executed is switched by the OS scheduler, the data used by the threads that have been executed is pushed out from the work memory 103 to the memory 110.
4. When a thread is moved from a heavily loaded processor 101 to a lightly loaded processor 101 consequent to the load distribution, the thread that is to be executed last after the migration to the lightly loaded processor 101 is selected as the thread to be migrated, and the data on the work memory 103 is migrated by DMA sometime between the migration of the thread and the actual execution thereof by the OS scheduler.
5. An area on the memory 110 is divided into an area shared by plural threads and an area dedicated for use by a single thread alone; on the work memory 103, an area that corresponds to the dedicated area used by a single thread is established. Data on the work memory 103 is used through address translation. When data on the work memory 103 is pushed out, the data is copied, by the DMA, onto a corresponding area in the memory 110, and then the area is released. When an area is again established on the work memory 103, data is copied from the memory 110 onto the work memory 103 by the DMA.

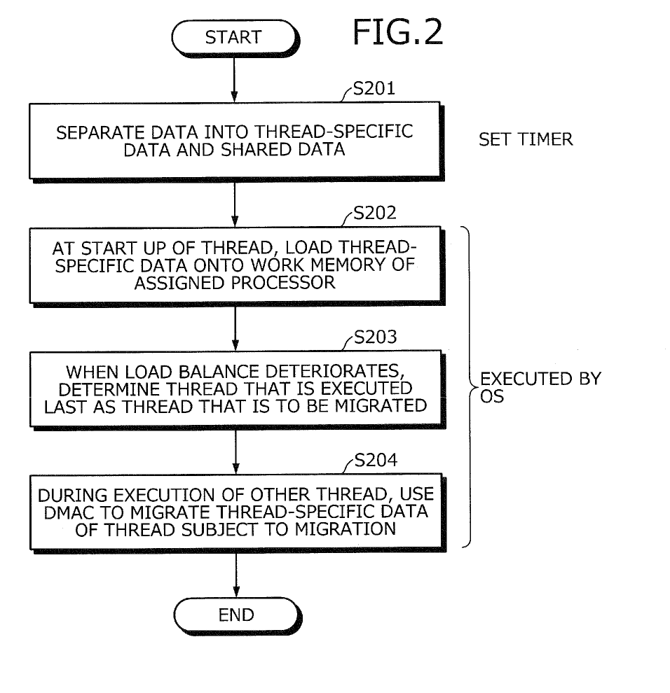

FIG. 2 is a flowchart of an example of data processing according to the embodiment. First, at the time of design, data of threads of a process are manually separated into thread-specific data and shared data that are shared among the threads (step S201). Thereafter, at thread start-up, a data processing apparatus 100 loads thread-specific data onto the work memory 103 of the assigned processor (step S202). When the load balance deteriorates, a heavily loaded processor 101 determines the thread that is executed last to be a thread that is to be migrated (step S203). During the execution of the other threads, thread-specific data of the thread (Thread 2 in the above example) to be migrated is migrated via the DMAC 111 (step S204). The operations at steps S202 to S204 are performed by the OS 201 during thread execution.

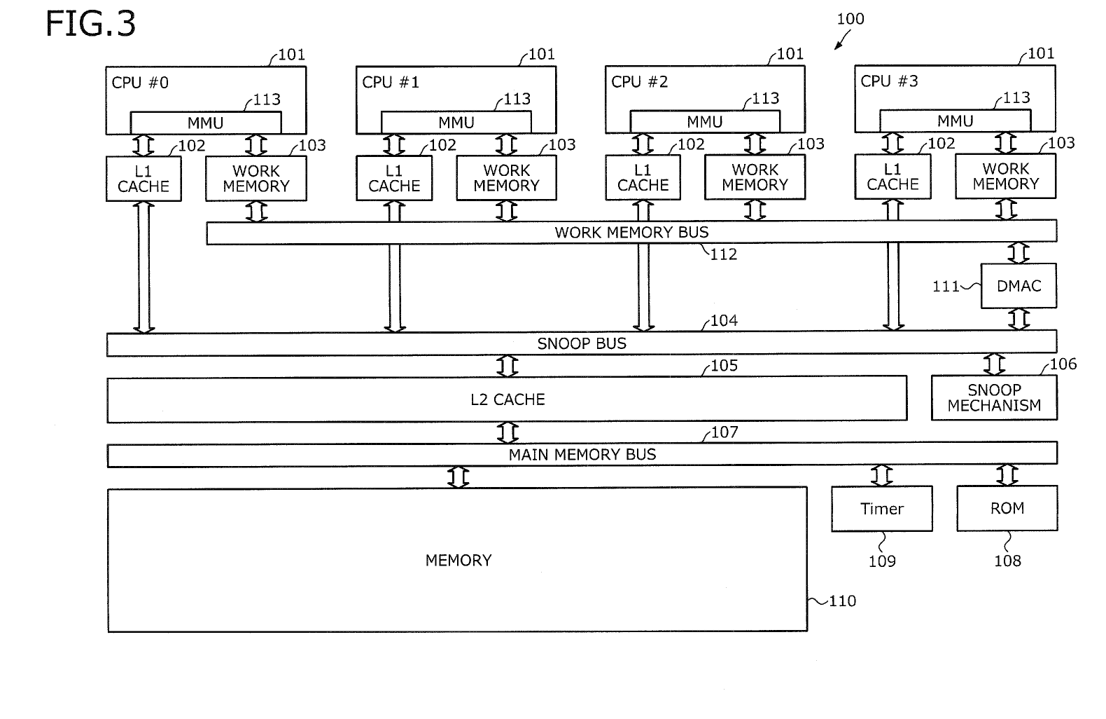

FIG. 3 is a block diagram of a hardware configuration of the data processing apparatus according to a first embodiment. The data processing apparatus 100 in the form of a single computer included in a system includes plural processors (CPUs #0 to #3) 101. The plural processors 101 each include a first level cache (L1 cache) 102 and work memory (first memory) 103. The L1 caches 102 are connected, via a snoop bus 104, to a second level cache (L2 cache) 105 and a snoop mechanism 106. The snoop mechanism 106 provides a coherency control such that the same variable on the L1 caches 102 indicates the same value.

The L2 cache 105 is connected, via a main memory bus 107 (second bus), to ROM 108 and to the memory (second memory) 110. A timer 109 is connected to the main memory bus 107. In the configuration of FIG. 1, the DMAC 111 is connected to both a work memory bus (first bus) 112 and the snoop bus 104, enabling access to each work memory 103 and, via the L2 cache 105, to the memory 110.

The processors 101 are each equipped with a memory managing unit (MMU) 113 for translation between a logical address indicated by software and a physical address.

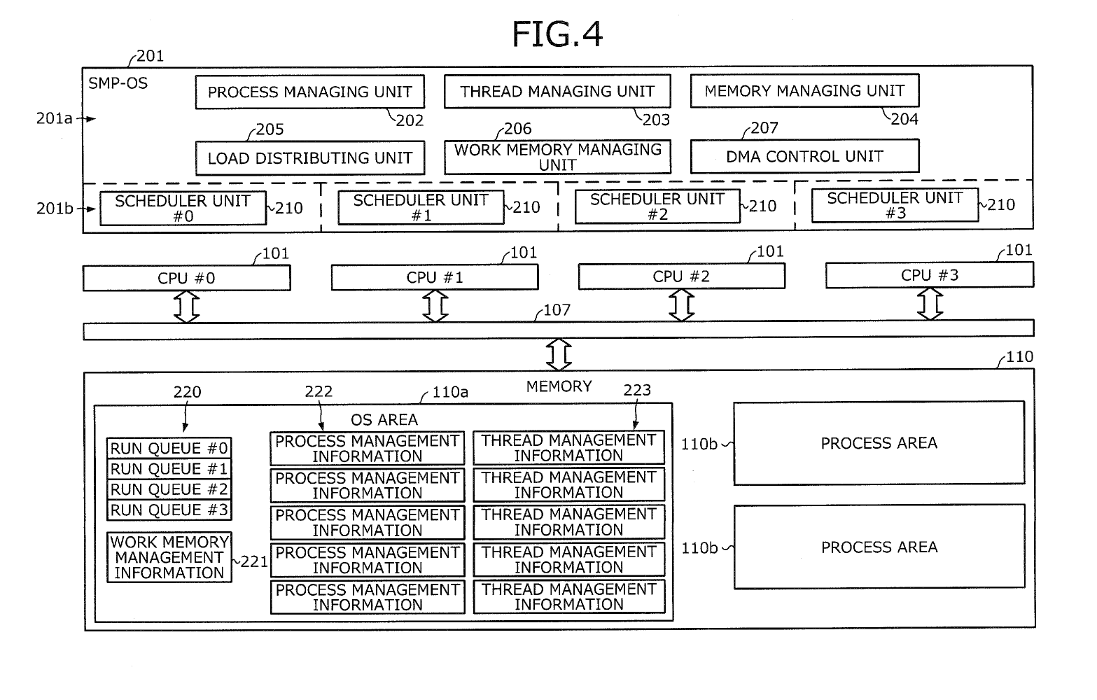

FIG. 4 is a block diagram of a software configuration of the data processing apparatus according to the first embodiment. A symmetric multiple processor (SMP)-OS 201 is installed across plural processes as software installed in the data processing apparatus 100. Internally, the OS 201 is separated into a common processing unit 201a that performs common processing by the plural processors 101 and an independent processing unit 201b that performs independent processing for each of the processors 101.

The common processing unit 201a includes a process managing unit 202 that manages processes, a thread managing unit 203 that manages threads, a memory managing unit 204 that manages the memory 110, a load distributing unit 205 that performs load distribution processing, a work memory managing unit (memory managing unit) 206 that manages the work memory 103, and a DMA controlling unit 207 that controls the DMAC 111.

The process managing unit 202, the thread managing unit 203, and the memory managing unit 204 manage processing needed to be commonly performed among the plural processors 101. The load distributing unit 205 implements the load distribution processing to be performed across the plural processors 101 by enabling the processors 101 to communicate with each other. Thus, threads running on the OS 201 act in the same manner on all the processors 101.

Meanwhile, the independent processing unit 201b that performs processing independently for each of the processors 101 includes plural scheduler units (#0 to #3). The scheduler units 210 perform time-sharing execution of executable threads assigned to respective processors 101.

The memory 110 is partitioned, by the memory managing unit 204 of the OS 201, into an OS area 110a used by the OS 201 and a process area 110 used by the processes. The OS area 110a used by the OS 201 stores various types of information. In the first embodiment, the OS area 110a includes run queues 220 that record active threads assigned to the processors 101, management information 221 concerning each work memory 103, management information 222 concerning processes, and management information 223 concerning threads.

Actions of threads in the first embodiment and management of areas on each work memory 103 will be described with respect to processing when an application is executed. First, when an instruction is issued to newly start up an application, the process managing unit 202 reads from the ROM 108, an execution object that corresponds to the application that is subject to start up.

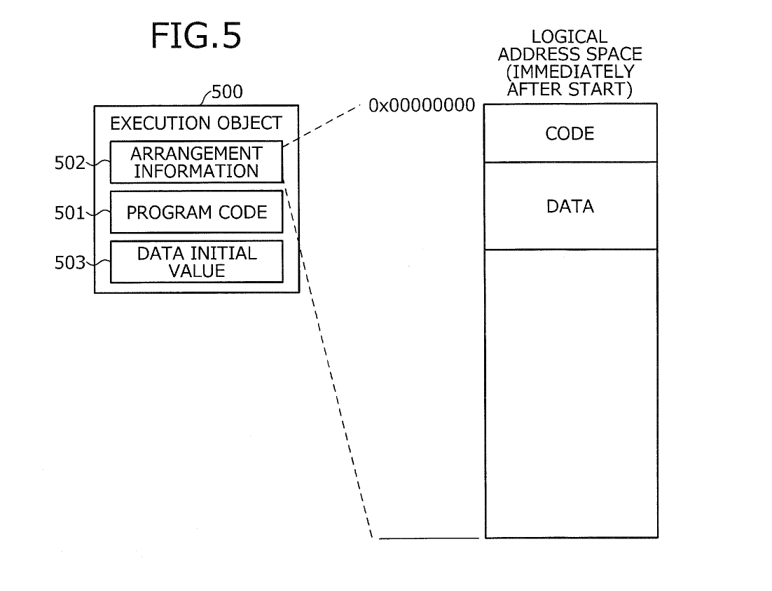

FIG. 5 is a chart of information concerning the execution object. An execution object 500 includes program code (code) 501 of an application and arrangement information 502 for specifying the logical address at which the code 501 and data used by the code 501 are to be located. The execution object 500 further includes information on data initial value 503 for data having an initial value. When the process managing unit 202 reads in the code 501 to generate process information for executing an application, the memory managing unit 204 establishes on the memory 110, the process area 110b required for loading the code and data recorded in the arrangement information 502.

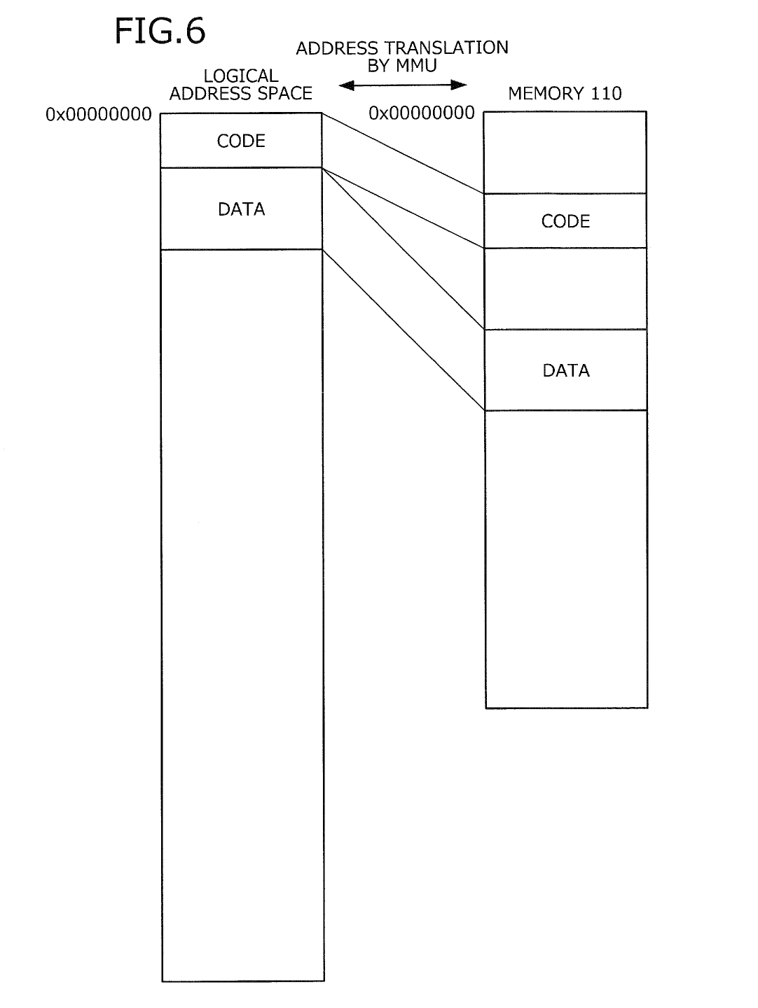

FIG. 6 is a chart of translation between the logical address and the physical address. Since addresses (physical addresses) on the memory 10 are translated by the MMU 113 into the logical address space, cases where the secured address is different from the logical address specified by the arrangement information 502 do not prose a problem. After the process area 110b is established, the code 501 and data recorded in the execution object 500 are copied onto the established area of the memory 110. Logical-physical address translation information of the MMU 113 is recorded into the process management information 222 so that when a thread belonging to the process is executed, the address translation information recorded in the process management information 222 is set in the MMU 113.

Thereafter, the thread managing unit 203 creates a thread acting as a main thread in the process, allowing the main thread to start to process the code from the beginning thereof. The thread managing unit 203 generates the thread management information 223 in the OS area 110a on the memory 110 and then establishes a stack area for the thread in the process area 110b to which the thread belongs. The thread management information 223 includes the address, size, state, etc. of the thread. The stack area is an area in which automatic variables in a C-language program are placed. The stack area is provided for each thread according to the nature thereof.

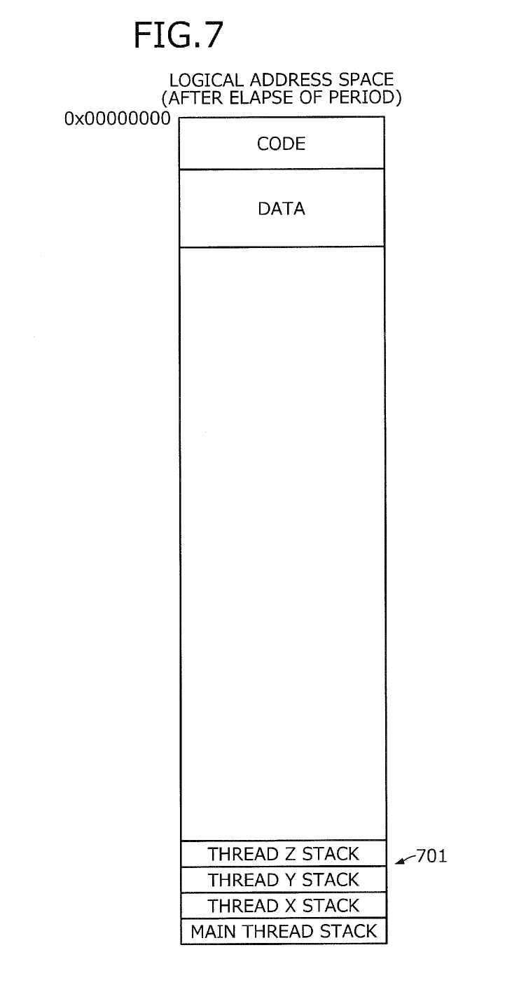

FIG. 7 is a chart of stack areas according to thread. Although only a main thread stack immediately after the startup of the process appears, if for example three threads X, Y, and Z are activated with the progress of the process execution, a stack area 701 appears for each of the threads as depicted. The size of the stack area 701 can be specified at the time of the thread startup, but if not particularly specified, the stack area 701 is created with the system default size.

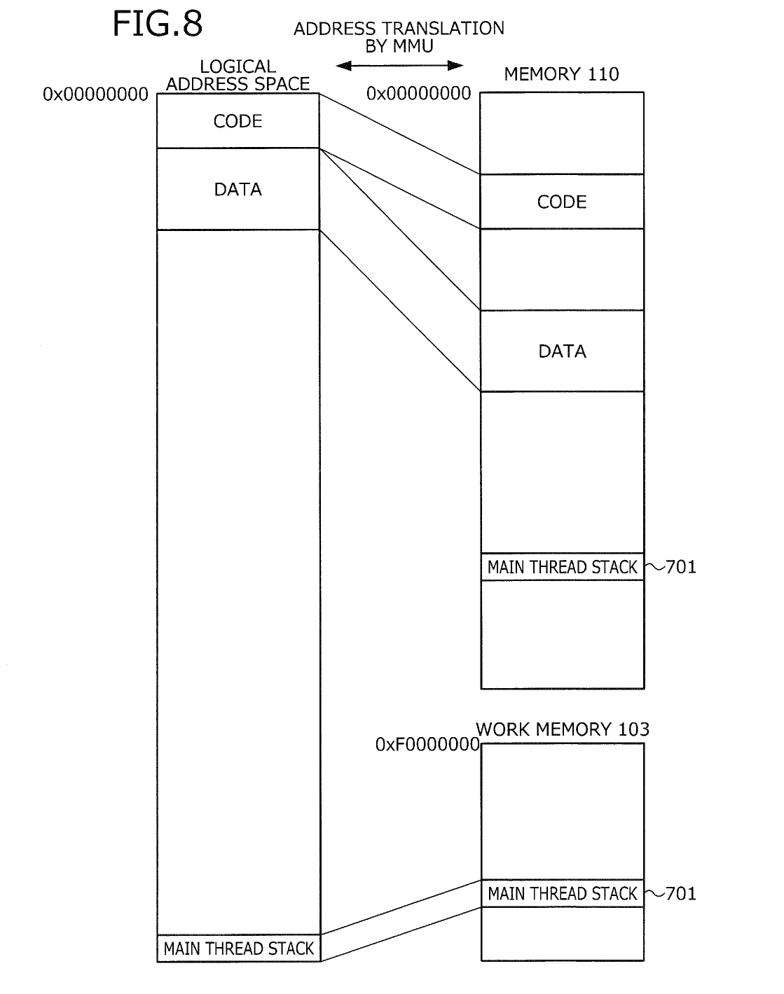

FIG. 8 is a chart of a stack area arrangement. Although the stack area 701 is an area possessed independently by each thread as described above, the stack area 701 can be arranged in the work memory 103. Thus, the stack area 701 is prepared on the work memory 103 by the work memory managing unit 206 to enable utilization by the thread via address translation effected by the MMU 113 as depicted.

However, since a thread execution processor 1 is undetermined at this stage, the stack area 701 is established on the memory 110. This stack area 701 is used when the stack area 701 secured on the work memory 103 is saved to the memory 110 thereafter. After generating the thread management information 223, the thread managing unit 203 provides the generated thread management information 223 to the load distributing unit 205.

The load distributing unit 205 calculates the loads on the processors 101 and provides the thread management information 223 to the scheduler unit 210 of the most lightly loaded processor 101. The scheduler unit 210 adds the received thread management information 223 to the run queue 220 of the scheduler unit 210, with the stack area 701 being established on the work memory 103 by the work memory managing unit 206. The scheduler unit 210 executes the threads one after another based on the thread management information 223 entered in the run queue 220.

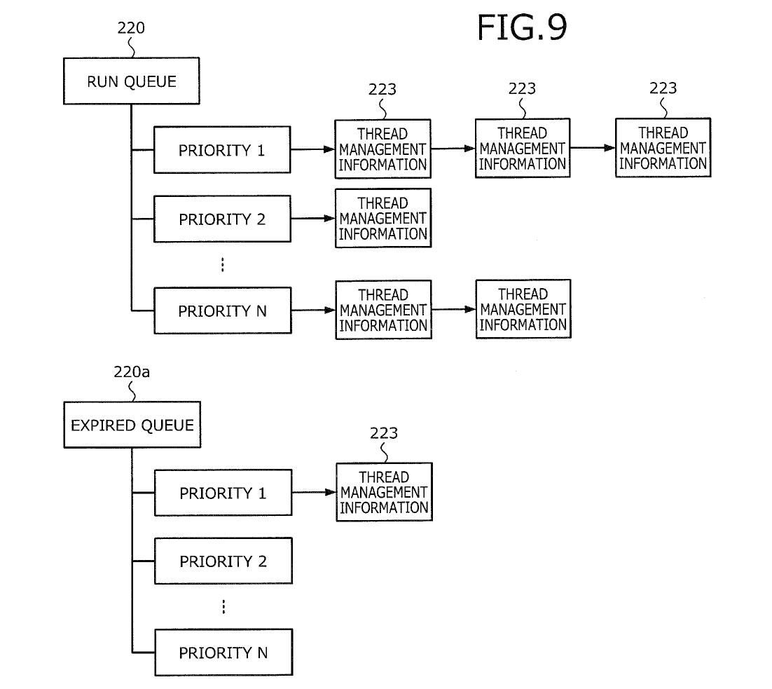

FIG. 9 is a diagram of a run queue implementation example. The configuration of the run queue 220 and the action of the scheduler unit 210 will be described in detail based on an implementation example. The run queue 220 is implemented as depicted using two different queues, i.e., the run queue 220 and an expired queue 220a. In such an implementation using two different queues, the run queue 220 and the expired queue 220a have respective priority (1 to N) lists of ranges settable in threads and each entry of the thread management information 223 is connected to a list corresponding to the priority.

The scheduler unit 210 fetches and executes one entry of the thread management information 223 from the head of a high-priority list of the run queue 220. Here, one execution period is a short period on the order of several microseconds and the execution time is set based on a priority such that a higher-priority thread is executed for a longer period. After the elapse of a predetermined period, the thread execution is interrupted to add the executed thread management information 223 to the end of the same-priority list of the expired queue 220a.

The above processing is repeated and, when the run queue 220 becomes empty, the expired queue 220a replaces the run queue 220 so that the same processing is again repeated. As a result, plural threads appear to be running at the same time on a single processor 101. In the following description, if not otherwise described, the entirety including the run queue 220 and the expired queue 220a is referred to as the run queue 220.

As described above, the order of execution of threads can be recognized from the contents of the run queue 220. Thus, when establishing the stack area 701 on the work memory 103, the work memory managing unit 206 checks the run queue 220 if an area sufficient for the stack area 701 is not available in the work memory 103. The work memory managing unit 206 looks at the run queue 220 and if the work memory 103 has a stack area 701 of a thread that is executed later than the object thread, the stack area 701 is moved to the memory 110 via the DMAC 111.

When the area of the memory 110 becomes available, the stack area 701 of the object thread is placed on the work memory 103. If the work memory 103 has no stack area 701 of a thread that is executed later than the object thread, the stack area 701 is not established on the work memory 103 at this stage.

If a thread is present whose stack area 701 is not on the work memory 103, similarly, when switching threads to be executed by the scheduler unit 210, the stack area 701 of the executed thread is moved to the memory 110 concurrently with the switching. Among threads that are close in the execution sequence, the stack area 701 of a thread whose stack area 701 is not on the work memory 103 is migrated from the memory to an available area of the work memory 103.

Although threads are assigned to the most lightly loaded processor 101 by the load distributing unit 205 at the time of startup, the loads between processors 101 may become unbalanced if some already-activated threads end without the startup of other threads for a long time. Therefore, the load distributing unit 205 is invoked when a thread switched or ends, and performs the load distribution processing if the difference of load of the most heavily loaded processor 101 and the most lightly loaded processor 101 exceeds a specified value.

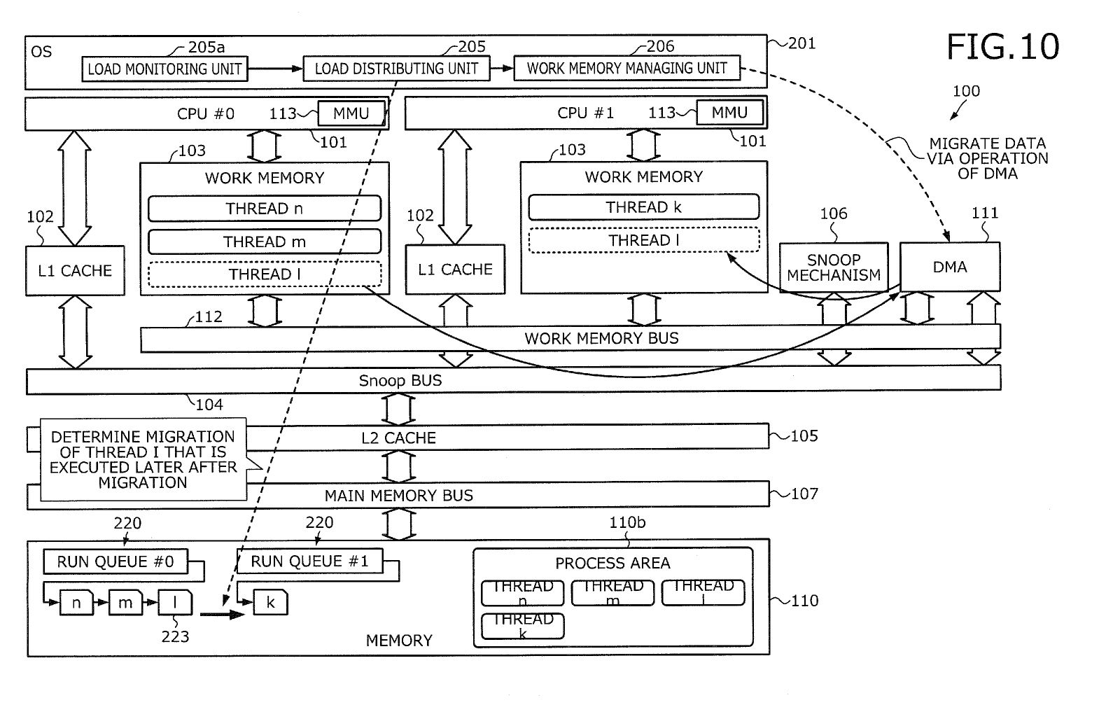

FIG. 10 is a diagram of thread migration during the load distribution processing. Description will be given by way of an example depicted in FIG. 10. In the load distribution processing, a thread is migrated from the most heavily loaded processor (CPU #0) 101 to the most lightly loaded processor (CPU #1) 101. Conventionally, a thread to be migrated is arbitrarily selected from a heavily loaded processor 101. In this embodiment, on the contrary, the run queue 220 of the lightly loaded processor (CPU #1) 101 is referred to under the load monitoring by a load monitoring unit 205a so that the thread to be subject to migration is a thread (Thread I in the depicted example) that is executed last after migrating the thread to the lightly loaded processor (CPU #1) 101.

When the thread to be migrated has been determined, the load distributing unit 205 provides the thread management information 223 of the thread to the scheduler unit 210 of the lightly loaded processor 101 and registers the thread into the run queue 220. The work memory managing unit 206 migrates the stack area 701 of the thread. In the migration of the stack area 701, similar to the thread startup, the stack area 701 is migrated as is if the work memory 103 of the destination processor (CPU #1) 101 has a sufficient area, and if not, the stack area 701 of a later-executed thread is emptied or the stack area 701 is temporarily migrated to the memory 110 and migrated back to the work memory 103 when the execution of the corresponding thread draws near.

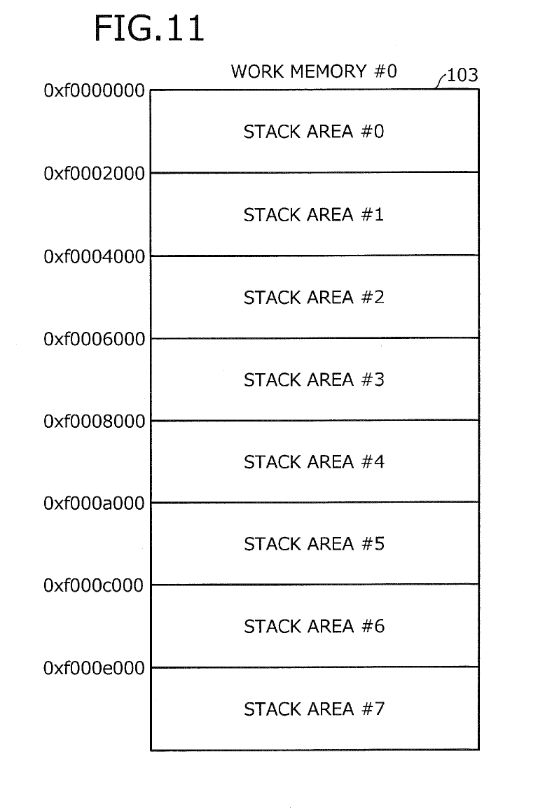

FIG. 11 is a chart of work memory management by the work memory managing unit. Work memory management by the work memory managing unit 206 will be described. The work memory managing unit 206 divides the work memory 103 into the default stack size for management. For example, if the work memory (#0) 103 is 64 Kbytes in size and the default stack size is 8 Kbytes, the work memory (#0) 103 is divided into eight areas as depicted. The work memory managing unit 206 then generates the work memory management information 221 for the memory 110.

The work memory management information 221 includes, for each identification information 1101 entry of the stack area 701, an in-use flag 1102 indicating whether the stack area 701 is in use, an under transfer flag 1103 indicating whether the stack area 701 is being migrated, and identification information 1104 of a thread currently using the stack area 701. The in-use flag 1102 of the work memory 103 has an initial value (set) of True with a reset of False. The under transfer flag 1103 becomes True (under migration) when data is being transferred and becomes False when data is in a state other than the under migration.

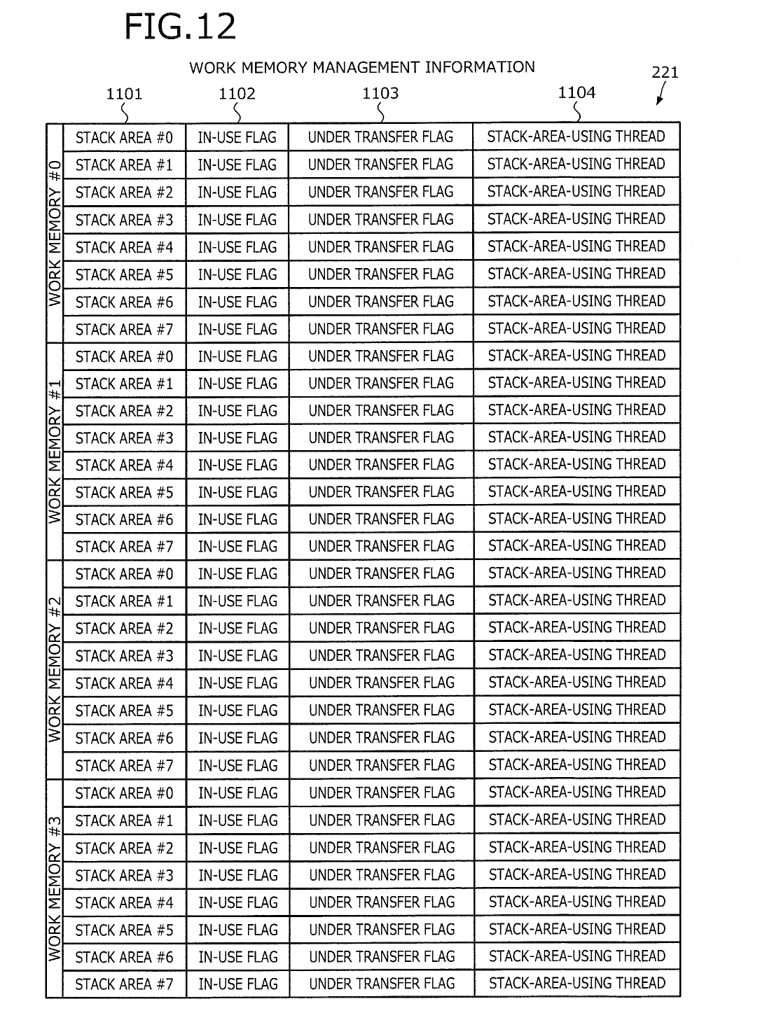

FIG. 12 is a chart of an example of the work memory management information. In the example depicted in FIG. 3, four processors 101 (CPU #0 to #3) are provided and each has a work memory 103 of the same size, the work memory management information 221 of the work memory 103 stores includes, as depicted, information concerning each processor 101, for each of the plural stack areas 701.

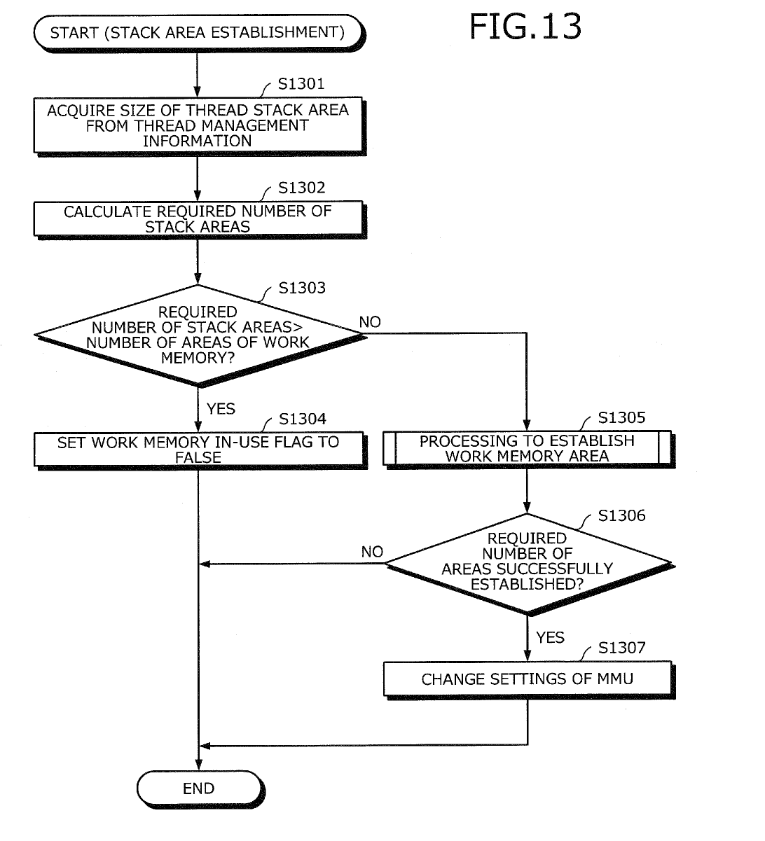

FIG. 13 is a flowchart of contents of processing for establishing stack areas. The work memory managing unit 206 establishes areas on the work memory 103 for newly created threads. First, the work memory managing unit 206 acquires the size of the thread stack area 701 from the thread management information 223 (step S1301) and calculates the number of stack areas required (step S1302). The work memory managing unit 206 compares the required number of stack areas and the number of areas of the work memory 103 (step S1303).

If the required number of stack areas is greater than the number of areas of the work memory 103 (step S1303: YES), the stack area 701 cannot be load onto the work memory 103 and consequently, the work memory managing unit 206 sets the in-use flag 1102 of the thread management information 223 for the work memory 103 to False (step S1304) to end the processing. In this case, the corresponding thread uses the stack area 701 established on the memory 110 without using the work memory 103.

On the other hand, if the required number of stack areas is not greater than the number of areas of the work memory 103 (step S1303: NO), the work memory managing unit 206 executes processing to establish an area on the work memory 103 (step S1305) and determines whether the required number of areas of the stack area 701 is successfully established (step S1306). If the required number of areas of the stack area 701 is not successfully established (step S1306: NO), the processing ends. If the required number of areas of the stack area 701 is successfully established (step S1306: YES), the work memory managing unit 206 changes the settings of the MMU 113 (step S1307) to end the processing.

This enables translation into the physical addresses that correspond to the areas on the work memory 103 established by the logical addresses of the stack area 701. Since the stack area 701 needs not have an initial value, there is no need to set a value to the established stack area 701.

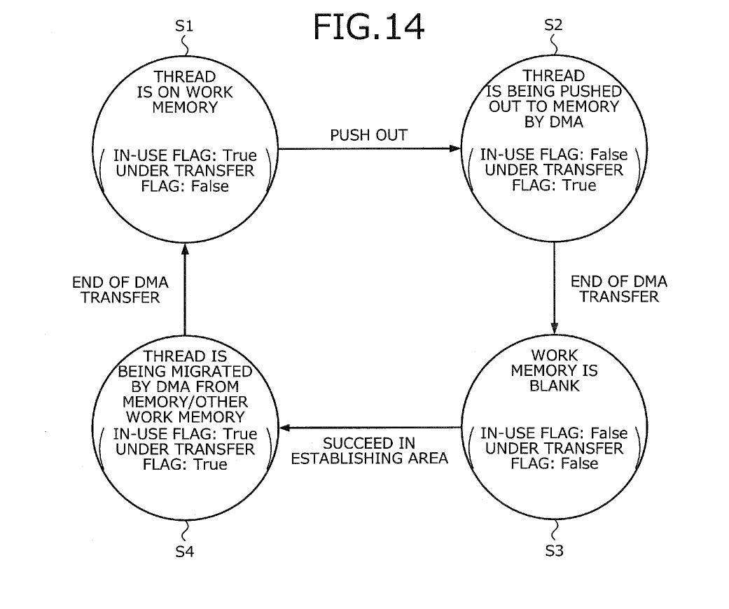

FIG. 14 is a transition diagram of state transition of an area on the work memory. An area on the work memory 103 has four different states. A transition state S1 is a state where a thread is on the work memory 103, with the in-use flag 1102 being True, the under transfer flag being False. The state shifts to a transition state S2 when the thread is pushed out from the work memory 103. The transition state S2 is a state where the thread is being pushed out to the memory 110 by the DMAC 111, with the in-use flag 1102 being False, the under transfer flag 1103 being True.

When the thread DMA transfer from the work memory 103 ends, the state then shifts to a transition state S3 where the work memory becomes blank. In the transition state S3, the in-use flag 1102 becomes False and the under transfer flag 1103 also becomes False. Thereafter, when an area of the work memory 103 is successfully established, the state shifts to a transition state S4 where the thread is being transferred to the work memory 103. The transition state S4 corresponds to transfer from the memory 110 or from another work memory 103, by the DMAC 111. In the transition state S4, the in-use flag 1102 becomes True and the under transfer flag 1103 also becomes True.

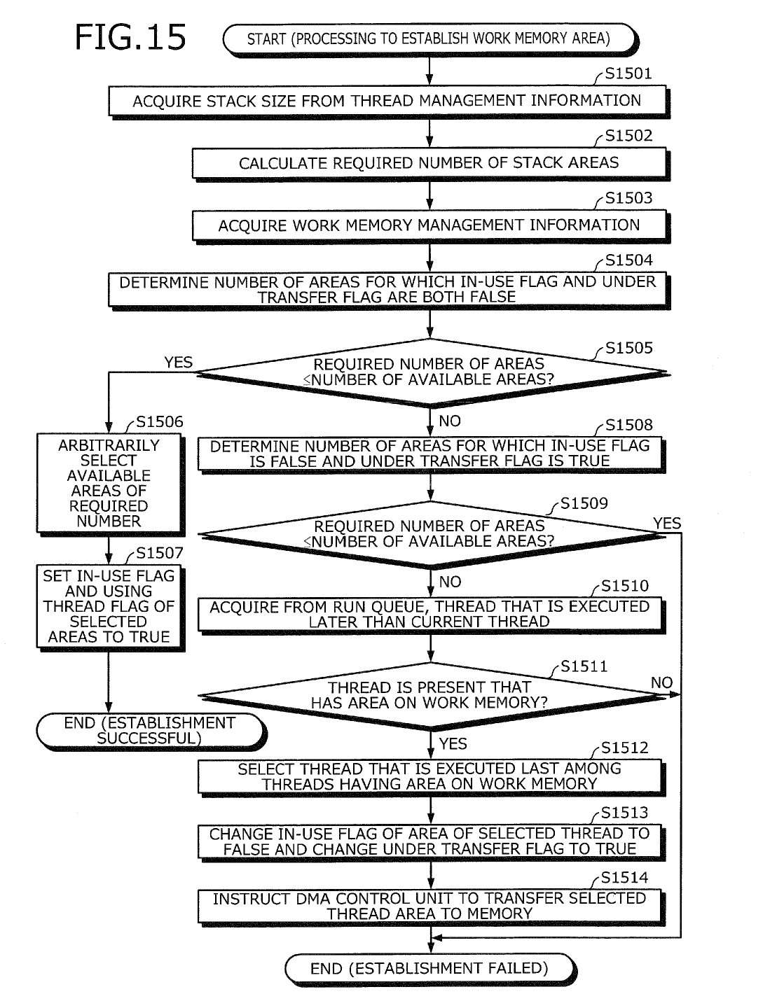

FIG. 15 is a flowchart of processing to establish a work memory area. Description will be given of contents of processing performed by the work memory managing unit 206, indicated at step S1305 in FIG. 13. In the processing to establish an area of the work memory 103, the work memory managing unit 206 acquires the size of the stack area 701 from the thread management information 223 (step S1501), and determines the number of stack areas required (step S1502). The work memory managing unit 206 acquires the work memory management information 221 (step S1503) and from the work memory management information 221, obtains the available area of the work memory 103.

As depicted in the state transition diagram of FIG. 14, areas on the work memory 103 have four different states. The work memory managing unit 206 determines the number of available areas in the transition state S3 where the in-use flag 1102 and the under transfer flag 1103 are both False (step S1504).

The work memory managing unit 206 determines whether the required number of areas is not greater than the number of available areas (step S1505). If the required number of areas is not greater than the available number of areas (step S1505: YES), the work memory managing unit 206 arbitrarily selects available areas of the required number (step S1506) and sets the in-use flag 1102 and the using thread 1104 of the selected areas to True (step S1507) to end the processing with a success in establishing the work memory area.

At step S1505, if the required number of areas is greater than the available number of areas (step S1505: NO), the work memory managing unit 206 determines the number of areas for which the in-use flag 1102 is False and the under transfer flag 1103 is True (step S1508). The work memory managing unit 206 uses the result at step S1508 to determine whether the required number of areas is not greater than the available number of areas (step S1509). If the required number of areas is not greater than the available number of areas (step S1509: YES), the processing ends with a failure in establishing the work memory area.

At step S1509, if the required number of areas is greater than the available number of areas (step S1509: NO), the work memory managing unit 206 acquires from the run queue 220, a thread that is executed later than the current thread (step S1510). The work memory managing unit 206 determines whether a thread is present that has an area on the work memory 103 (step S1511). If no thread having an area on the work memory 103 is present (step S1511: NO), the processing ends with a failure in establishing the work memory area. If there is a thread having an area on the work memory 103 (step S1511: YES), the work memory managing unit 206 selects the thread that is executed last among threads having an area on the work memory 103 (step S1512).

The work memory managing unit 206 changes the in-use flag 1102 of the area of the selected thread to False and changes the under transfer flag 1103 to True (step S1513, transition state S2). Thereafter, the work memory managing unit 206 instructs the DMA control unit 207 to transfer the selected thread area to the memory 110 (step S1514) to end the processing with a failure in establishing the work memory area.

Through the above processing, the thread is migrated to the memory 110 via the DMAC 111 so that the area of the work memory 103 is released. Since the migration by the DMAC 111 is performed in the background, the DMA control unit 207 merely has to be instructed to perform the transfer. When the transfer by the DMAC 111 ends, the DMAC 111 interrupts and notifies the processor 101 of the completion of the transfer. When receiving this notification, the DMA control unit 207 notifies the work memory management unit 206 of the end of the DMA transfer.

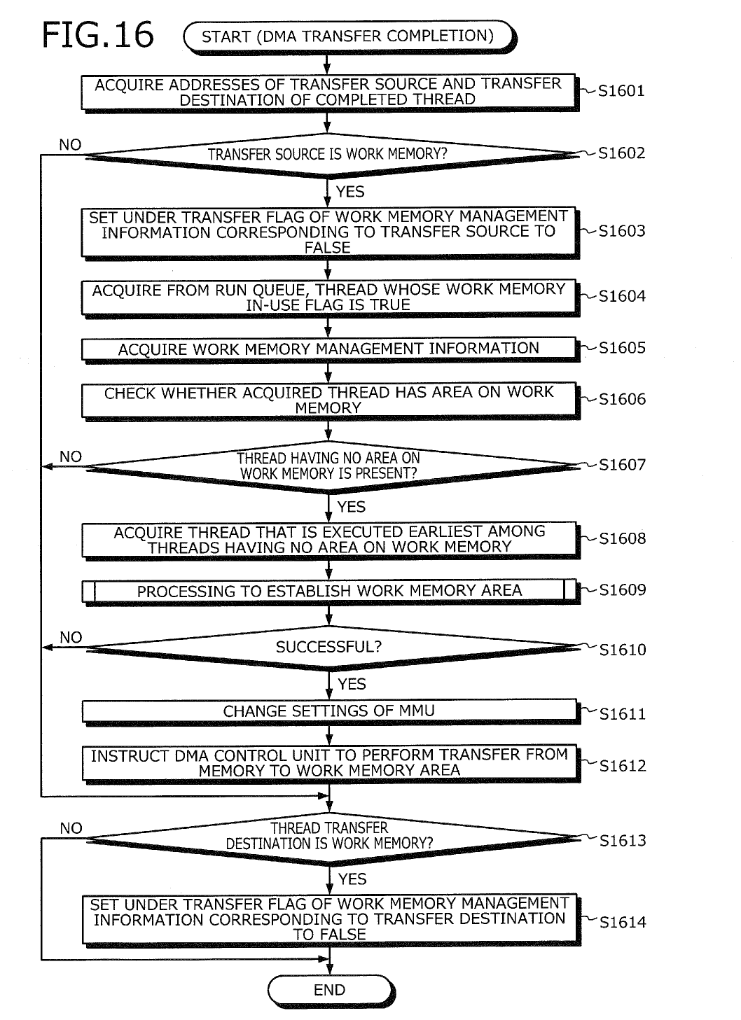

FIG. 16 is a flowchart of processing after the completion of the DMA transfer. Processing performed by the work memory managing unit 206 will be described. When receiving notification of the completion of the DMA transfer from the DMA control unit 207, the work memory managing unit 206 acquires addresses of the transfer source and the transfer destination of the completed thread (step S1601). The work memory managing unit 206 determines whether the transfer source is the work memory 103 (step S1602). If the transfer source is not the work memory (step S1602: NO), the procedure proceeds to step S1613.

If the transfer source is the work memory 103 (step S1602: YES), the work memory managing unit 206 sets the under transfer flag 1103 of the work memory management information 221 corresponding to the transfer source to False (step S1603). The work memory managing unit 206 acquires from the run queue 220, a thread whose work memory 103 in-use flag 1102 is True (step S1604). The work memory managing unit 206 acquires the work memory management information 221 (step S1605) and checks whether the acquired thread has an area on the work memory 103 (step S1606).

The work memory managing unit 206 determines whether a thread having no area on the work memory 103 is present (step S1607). If no such thread is present (step S1607: NO), the procedure proceeds to step S1613. If such a thread is present (step S1607: YES), the work memory managing unit 206 acquires the thread that is executed earliest among threads having no area on the work memory 103 (step S1608) and executes processing for establishing a work memory area (see FIG. 15) (step S1609). The work memory managing unit 206 determines whether establishment of the work memory area on the work memory 103 is successful (step S1610).

If establishment of the work memory area on the work memory 103 is not successful (step S1610: NO), the procedure proceeds to step S1613, whereas if establishment of the work memory area on the work memory 103 is successful (step S1610: YES), the work memory managing unit 206 sets address translation information recorded in the process management information 222 for the MMU 113 so that the established area can be used as the stack area 701 (step S1611). The work memory managing unit 206 instructs the DMA control unit 207 to perform transfer from the memory 110 to the work memory area (step S1612).

At step S1613, the work memory managing unit 206 determines whether the thread transfer destination is the work memory 103 (step S1613) and if the transfer destination is not the work memory 103 (step S1613: NO), the processing comes to an end. If the transfer destination is the work memory 103 (step S1613: YES), the work memory managing unit 206 sets the under transfer flag 1103 of the work memory management information 221 corresponding to the transfer destination to False (step S1614) to end the processing.

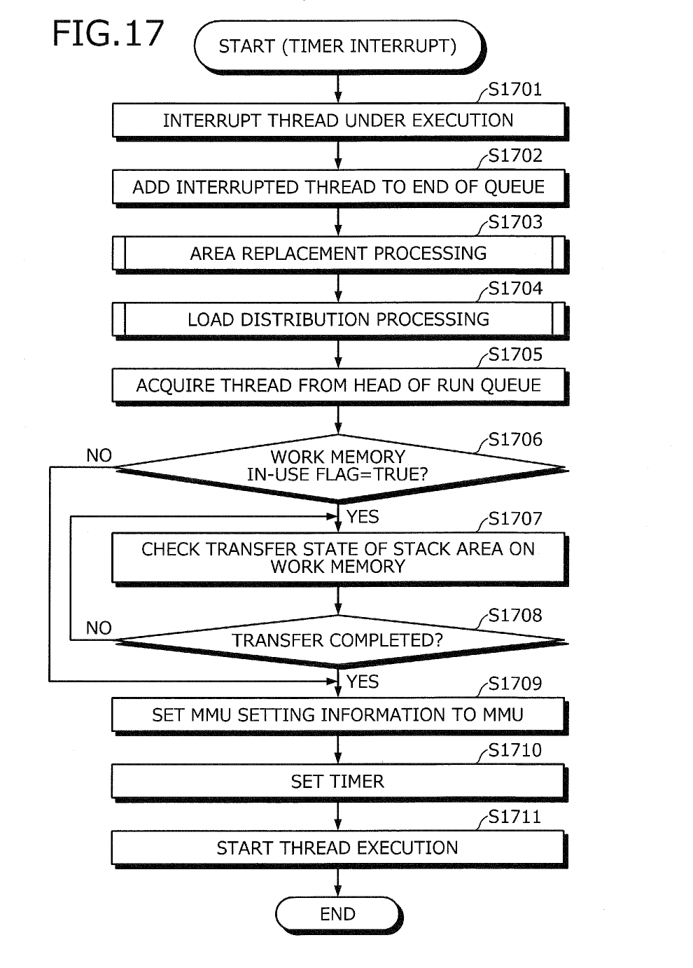

FIG. 17 is a flowchart of processing at the time of switching execution threads. The thread switching is performed by the scheduler unit 210 by an interruption of the timer 109. First, the scheduler unit 210 records into the thread management information 223, execution information for the thread that has been executed and interrupts the thread under execution (step S1701). The scheduler unit 210 adds the interrupted thread to the end of the queue (step S1702), and causes the work memory managing unit 206 to perform the area replacement processing (step S1703).

Thereafter, the scheduler unit 210 causes the load distributing unit 205 to perform the load distribution processing (step S1704). The scheduler unit 210 acquires from the head of the run queue 220, the thread to be executed next (step S1705), and determines whether the in-use flag 1102 of the work memory management information 221 is True (step S1706). If the in-use flag 1102 is not True (step S1706: NO), the procedure proceeds to step S1709.

If the in-use flag 1102 is True (step S1706: YES), the scheduler unit 210 checks the transfer state of the stack area 701 on the work memory 103 (step S1707). If the transfer is not yet completed (step S1708: NO), the scheduler unit 210 waits for the under transfer flag to becomes False via the DMAC 111 transfer completion processing. When the transfer comes to a completion (step S1708: YES), the scheduler unit 210 sets the MMU 113 based on the setting information of the MMU 113 recorded in the processing management information 222 to which the thread belongs (step S1709), sets the timer 109 (step S1710), and reads the thread execution information recorded in the thread management information 223 to start the execution of the thread (step S1711) to end the processing.

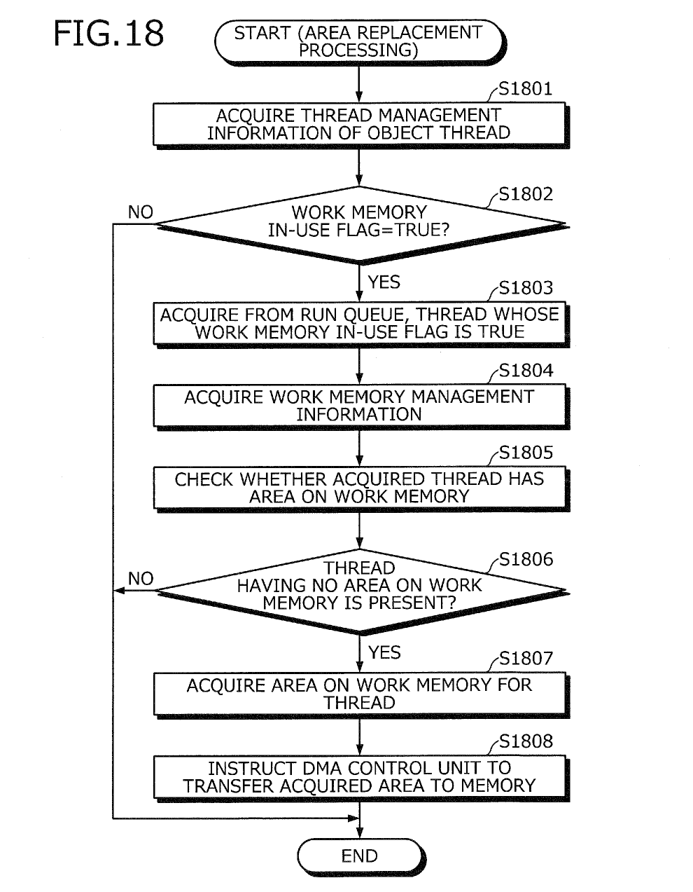

FIG. 18 is a flowchart of area replacement processing. Description will be given of processing for area replacement between the memory 110 and the work memory 103, performed by the work memory managing unit 206 and indicated at step S1703 in FIG. 17. Since the replacement is not needed if the stack areas 701 of all the threads are on the work memory 103, the area replacement processing is performed only when there is a thread having no stack area 701 on the work memory 103.

The work memory managing unit 206 acquires the thread management information 223 of an object thread for the area replacement (step S1801). The work memory managing unit 206 determines whether the in-use flag 1102 of the object thread of the work memory management information 221 is True (step S1802). If the in-use flag is not True (step S1802: NO), the processing comes to an end. If the in-use flag is True (step S1802: YES), the work memory managing unit 206 acquires from the run queue 220, threads whose in-use flag 1102 of the work memory 103 is True (step S1803). The work memory managing unit 206 acquires the work memory management information 221 (step S1804), and checks whether the acquired threads have an area on the work memory 103 (step S1805).

If no such thread is present (step S1806: NO), the processing comes to an end. If such a thread is present (step S1806: YES), the work memory managing unit 206 acquires an area on the work memory 103 for the thread (step S1807) and instructs the DMA control unit 207 to transfer the acquired area to the memory 110 (step S1808) to end the processing. In this manner, using the DMAC 111, the work memory managing unit 206 transfers the stack area 701 of the executed threads, from the work memory 103 to the memory 110. The work memory managing unit 206 establishes the stack area 701 of another thread in an available area created as a result of the transfer, i.e., execution of the DMA transfer end processing (see FIG. 16) after the completion of the transfer performed by the DMAC 111.

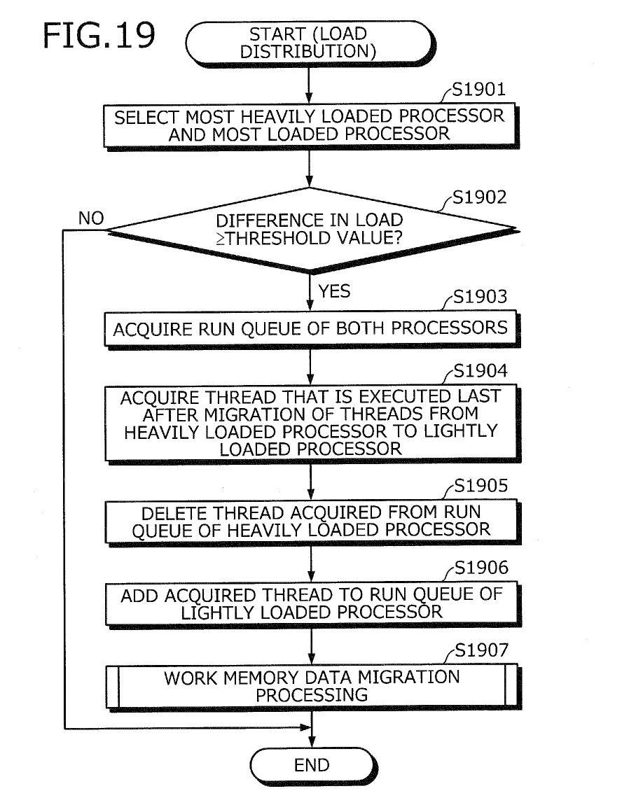

FIG. 19 is a flowchart of load distribution processing. Description will be given of processing performed by the load distributing unit 205, indicated at step S1704 in FIG. 17. The load distributing unit 205 selects the most heavily loaded processor 101 and the most lightly loaded processor 101 (step S1901), and compares the loads of the most heavily loaded processor 101 and the most lightly loaded processor 101 to determine if the difference in load is greater than or equal to a preliminarily set threshold value (step S1902). If the load difference is less than the threshold value (step S1902: NO), the processing is ended without performing the load distribution.

If the load difference is greater than or equal to the threshold value (step S1902: YES), the load distributing unit 205 acquires the run queues 220 of both the processors 101 (step S1903) to migrate threads from the heavily loaded processor 101 to the lightly loaded processor 101. The load distributing unit 205 acquires the thread that is executed last after the migration of threads from the heavily loaded processor 101 to the lightly loaded processor 101 (step S1904). The load distributing unit 205 deletes the thread acquired at step S1904 from the run queue 220 of the heavily loaded processor 101 (step S1905). The load distributing unit 205 adds the acquired thread to the run queue 220 of the lightly loaded processor 101 (step S1906). Thereafter, work memory data migration processing is performed (step S1907) to end the processing.

When a thread to be migrated is determined through the processing depicted in FIG. 19, the work memory managing unit 206 migrates data residing on the work memory 103. In the migration of the data residing on the work memory 103, the processing differs depending on whether the thread to be migrated has a stack area 701 on the work memory 103 of the migration source processor 101 or on whether a stack area 701 is established on the work memory 103 of the migration destination processor 101.

In cases where the area is on the work memory 103 of the migration source and where the area can be secured on the work memory 103 of the migration destination as well, data is directly transferred from the work memory 103 to the work memory 103 using the DMAC 111.

In the cases where the area is on the work memory 103 of the migration source but an area cannot be established on the work memory 103 of the migration destination, data is temporarily migrated to the stack area 701 on the memory 110. On the contrary, in cases where the area is not on the work memory 103 of the migration source but an area can be established on the work memory 103 of the migration destination, data is migrated from the stack area 701 on the memory 110 to the work memory 103. In the case of having no area on the work memory 103 of the e and in the case of failing to establish an area at the migration destination, no processing is performed. In this manner, management of data on the work memory 103 becomes possible.

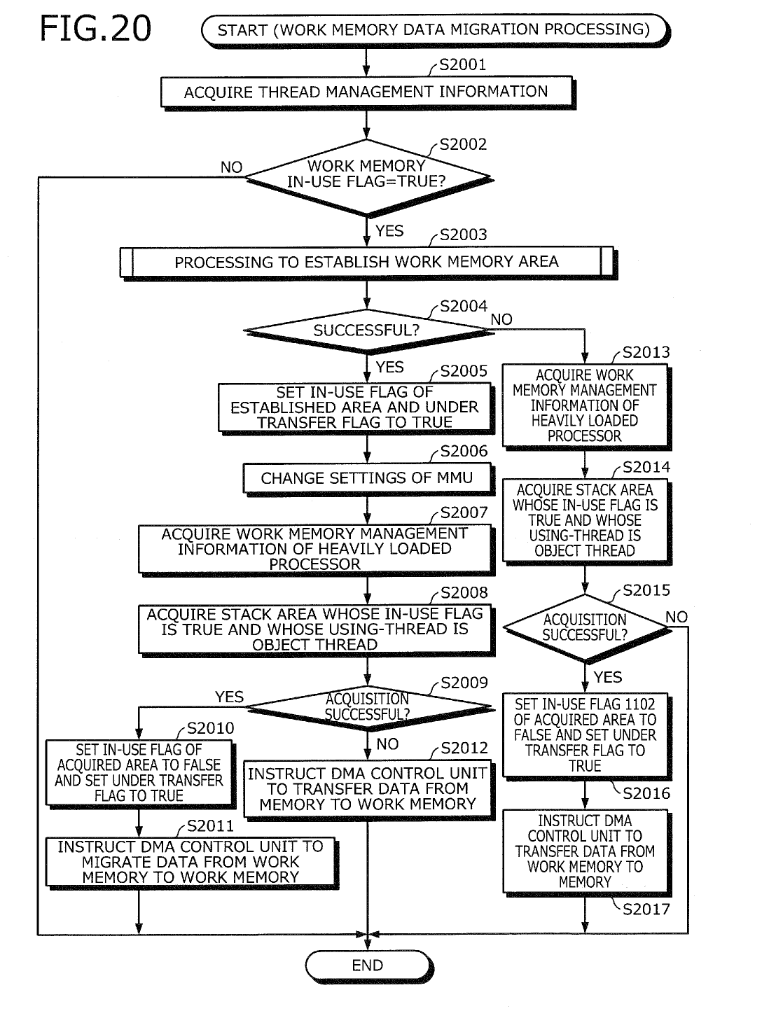

FIG. 20 is a flowchart of processing to migrate work memory data. Description will be given of processing performed by the work memory managing unit 206, indicated at step S1907 in FIG. 19. The work memory managing unit 206 first acquires the thread management information 223 of an object thread (step S2001). The work memory managing unit 206 determines whether the in-use flag 1102 of the work memory management information 221 is True (step S2002). If the in-use flag 1102 is not True (step S2002: NO), the processing comes to an end.

If the in-use flag 1102 is True (step S2002: YES), the work memory managing unit 206 performs the work memory area establishing processing (see FIG. 15) for the lightly loaded processor 101 (step S2003). If the execution results in a success in establishing the area on the work memory 103 (step S2004: YES), the operations at step S2005 and thereafter are executed, whereas if the execution results in a failure in establishing the area on the work memory 103 (step S2004: NO), the operations at step S2013 and thereafter are executed.

At step S2005, the work memory managing unit 206 sets the in-use flag 1102 of the established area on the work memory 103 and the under transfer flag 1103 to True (step S2005), changes the settings of the MMU 113 (step S2006), and acquires the work memory management information 221 of the heavily loaded processor 101 (step S2007). The work memory managing unit 206 acquires the stack area 701 whose in-use flag 1102 is True and whose using-thread is the object thread (step S2008), and determines whether the area acquisition is successful (S2009).

If the area acquisition is successful (step S2009: YES), the work memory managing unit 206 sets the in-use flag of the acquired area to False and sets the under transfer flag 1103 to True (step S2010), and instructs the DMA control unit 207 to transfer data from the work memory 103 to the same work memory 103 (S2011) to end the processing.

If the area acquisition fails (step S2009: NO), the work memory managing unit 206 instructs the DMA control unit 207 to transfer data from the memory 110 to the work memory 103 (step S2012) to end the processing.

At step S2004, if the area on the work memory 103 fails to be established (step S2004: NO), the work memory managing unit 206 acquires the work memory management information 221 of the heavily loaded processor 101 (step S2013). The work memory managing unit 206 acquires the stack area 701 whose in-use flag 1102 is True and whose using-thread is the object thread (step S2014), and determines whether the area acquisition is successful (step S2015). If not successful (step S2015: NO), the processing comes to an end.

If successful (step S2015: YES), the work memory managing unit 206 sets the in-use flag 1102 of the acquired area to False and sets the under transfer flag 1103 to True (step S2016), and instructs the DMA control unit 207 to transfer data from the work memory 103 to the memory 110 (step S2017) to end the processing.

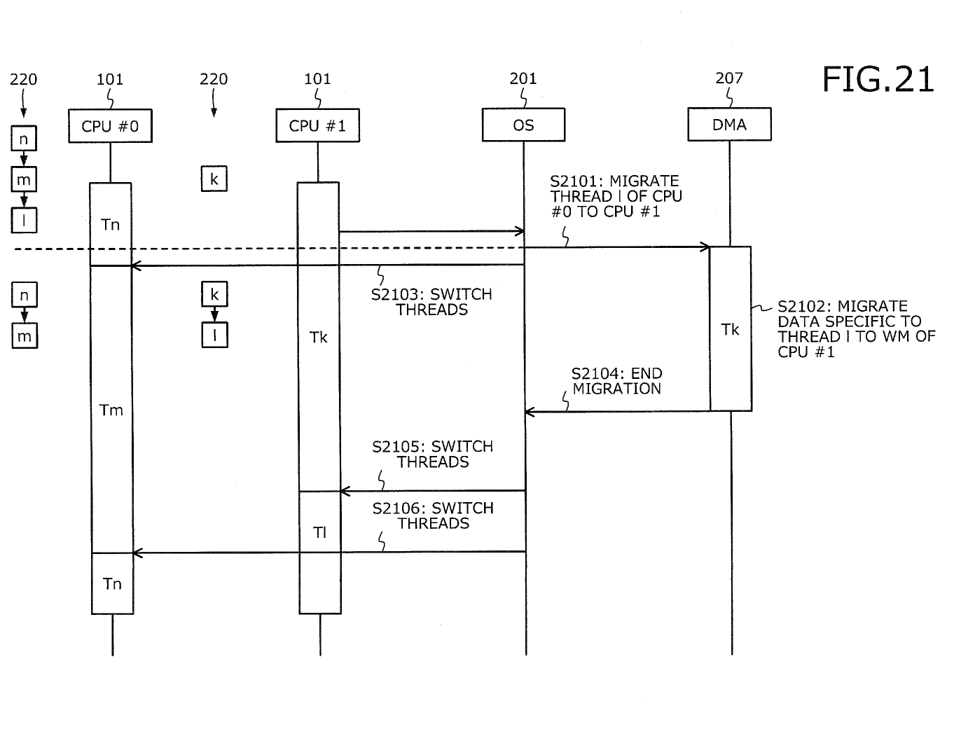

FIG. 21 is a sequence diagram of processing timing of the system according to the first embodiment. Description will be given of thread migration and the thread data migration using the DMAC 111. Details of processing of the plural processors (CPU #0 and #1) 101, the OS 201, and the DMA control unit 207 (DMAC 111) are shown with respect to time represented by the vertical axis.

The first processor (CPU #0) 101 is assumed to execute the processing in the order of threads n, m, and 1 in the run queue 220 and the second processor (CPU #1) 101 is assumed to execute the processing of a thread k in the run queue 220. Here, since the first processor (CPU #0) has a heavy load, the OS 201 is assumed to decide to have the load distributing unit 205 to perform the load distribution to migrate the thread 1 of the first processor (CPU #0) 101 to the second processor (CPU #1) 101 (step S2101).

The OS 201 allows data specific to the thread 1 to migrate to the work memory 103 of the second processor (CPU #1) (step S2102). As a result, the thread 1 to be processed next enters the run queue 220 of the second processor (CPU #1) 101. In the processing example of FIG. 21, the first processor (CPU #0) 101 is instructed to switch the threads during the migration of the data specific to the thread 1 (step S2103) so that the first processor (CPU #0) 101 executes threads n to m that are to be executed.

After the completion of the migration of the data specific to the thread 1 to the work memory 103 of the second processor (CPU #1) 101 by the DMA 207 (step S2104), the OS 201 issues an instruction for thread switching to next process and execute the thread 1 as a result of completion of the execution of the thread k by the second processor (CPU #1) 101 (step S2105). The first processor (CPU #0) 101 is also instructed to perform the thread switching to resume the thread n, as a result of the completion of the thread m (step S2106).

In this manner, according to the first embodiment, the thread-specific data is moved to the work memory of the migration destination processor during the execution of the plural threads based on time slice execution. The data migration is performed using the DMA, in parallel with thread execution by the processor. This enables the overhead at the time of the load distribution between the plural processors to be reduced.

In a case where the work memory of the migration destination has no available space, the thread execution order is changed according to priority and based on the execution order at the migration destination processor, to temporarily push out to the memory, thread data having a later execution order. This enables thread data to migrate to unused work memory, ensuring efficient thread execution and improved processing efficiency of the entire system having plural processors.

Although the first embodiment is configured to arrange only the stack area 701 on the work memory 103, some data areas may also have areas that are used only by specific threads. The second embodiment is a configuration example corresponding to a case where it is known from program analysis, etc. that data areas include data that is used only by specific threads.

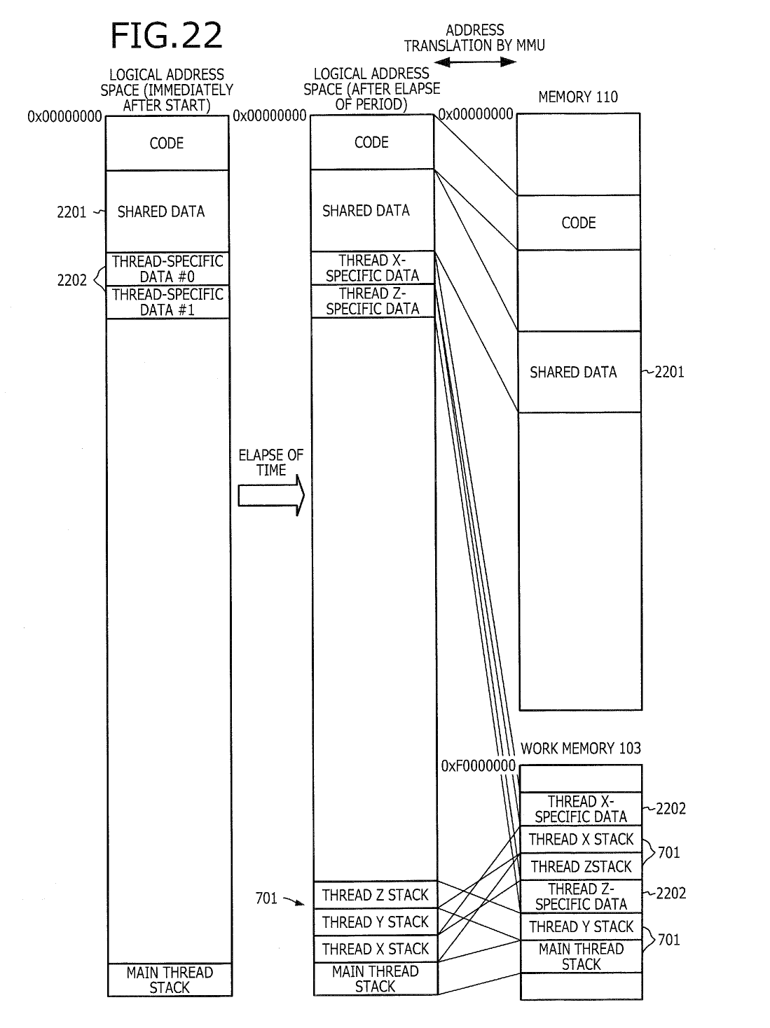

FIG. 22 is a chart indicating the arrangement of data areas according to the second embodiment. As depicted, a data area is separated into a shared data area 2201 and a specific data area 2202 and the execution module is created such that data used only by specific threads is placed in the specific data area 2202. At the stage of the execution module, data is managed by identification numbers (specific data #0, #1) due to the absence of threads and at the stage of creating threads, the data is associated with the threads (threads X, Y).

In the second embodiment, processing by the work memory managing unit 206 is basically similar to that in the first embodiment. Processing that differs includes including specific data areas in the stack area 701 through the settings of the MMU when determining the required areas. Due to the setting of an initial value in the specific data area 2202, when the establishment of an area is successful (step S2004) in the work memory data migration processing (FIG. 20), data in the specific data area 2202 on the memory 110 is migrated using the DMAC 111. Thus, according to the second embodiment, in addition to the advantages of the first embodiment, support is provided also to migrate to the work memory 103, data used only by specific threads.

In a third embodiment, description will be given of determination of data transfer when a thread that is executed in a short time is executed. There is a thread called an I/O thread that is executed irregularly only for a short time. Such a thread is, for example, a thread for processing input from a keyboard, etc. In many cases, these threads are handled as high-priority threads and are scheduled to be executed promptly after activation.

Accordingly, if the stack area 701 of such threads is placed on the work memory 103 without altering the processing described in the first and the second embodiments, the DMAC 111 data transfer may be late for the start of thread execution. However, many of such threads are not required to have a high processing performance and consequently even if the work memory 103 is not used, the threads have no problem in processing. Since such threads are executed irregularly for a short time, the thread need not be subjected to the load distribution.

Thus, to handle such threads, the third embodiment includes a work memory 103 fixation flag in the thread management information 223. For threads having no need to use the work memory 103 among the I/O threads, the initial value of the in-use flag 1102 of the work memory management information 221 is set to False. For threads that use the work memory 103 among the I/O threads, the initial values of both the in-use flag 1102 and the work memory 103 fixation flag are set to True. For ordinary threads, the initial value of the in-use flag 1102 of the work memory 103 is True and the initial value of the work memory 103 fixation flag is False.

When the initial value of the in-use flag 1102 of the work memory 103 is False, in the initial establishment processing (processing to establish stack area depicted in FIG. 13) of the work memory 103 area, the work memory managing unit 206 need not secure the area, irrespective of the size of the stack area 701. As a result, the in-use flag 1102 of the work memory 103 is False in the subsequent processing and consequently, processing related the work memory 103 is not performed.

When the work memory 103 fixation flag is True, in the processing to establish work memory areas (see FIG. 15) or in the area replacement processing (see FIG. 18), areas used by threads whose work memory 103 fixation flag is True are not selected as areas for transfer to the memory 110. This leads to a reduction in the number of areas of the work memory 103, so that when the available area is calculated (step S1504) in the area establishment processing (see FIG. 15), the areas used by threads whose work memory 103 fixation flag is True are excluded from calculation.

When a thread whose work memory 103 in-use flag is True newly establishes the areas, the required number of areas for all the threads entered in the run queue 220 are determined and from the practical maximum available number of areas (the number of areas of the work memory 103—the number of areas of the fixation flag), the work memory 103 in-use flag is reset. In this manner, the third embodiment enables processing for establishing the work memory 103 area and for migrating the thread to be excluded at the time of the execution of specific threads processed in a short time, thereby achieving improved processing efficiency of the entire system irrespective of the type of threads.

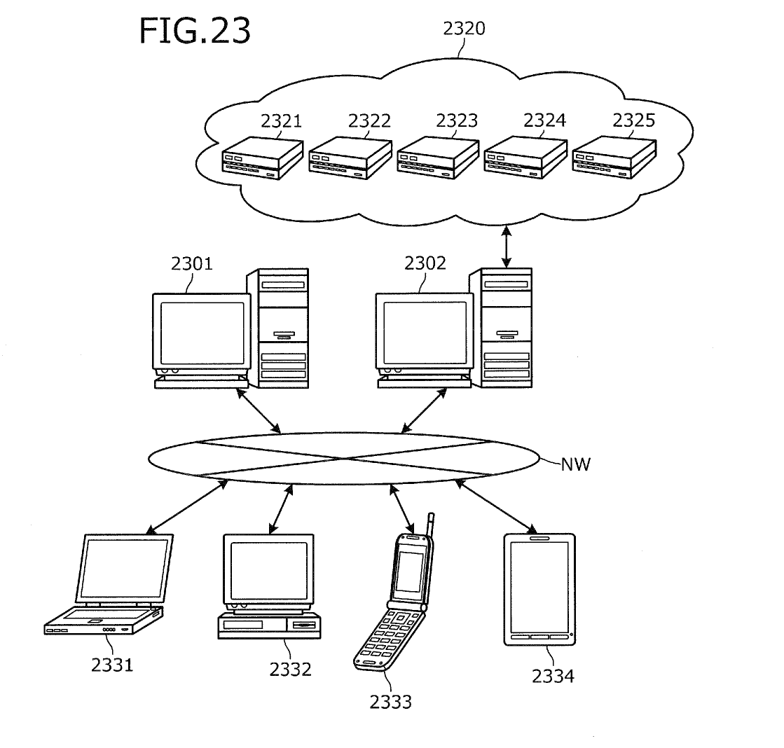

FIG. 23 is a diagram of an example of application to a system that employs the data processing apparatus depicted in FIGS. 3 and 4. In FIG. 23, a network NW is a network in which servers 2301 and 2302 are communicable with clients 2331 to 2334, the network NW being for example a local area network (LAN), a wide area network (WAN), Internet, or a mobile telephone network.

The server 2302 is a management server for a server group (servers 2321 to 2325) making up a cloud 2320. Among the clients 2331 to 2334, the client 2331 is a notebook PC, the client 2332 is a desktop PC, the client 2333 is a mobile phone (or alternatively, a smartphone or a personal handyphone system (PHS)), and the client 2334 is a tablet terminal. The servers 2301 and 2302 and 2321 to 2325 and the clients 2331 to 2334 of FIG. 23 are implemented by the data processing apparatus 100 depicted in FIGS. 3 and 4 for example.

The data processing apparatus 100 depicted in FIGS. 3 and 4 is applicable also to a configuration including plural data processing apparatuses 100, in which work memory 103 is provided for each of the plural data processing apparatuses 100, with the memory 110 being shared by the plural data processing apparatuses 100, threads being migrated between the plural data processing apparatuses 100. Another configuration is also possible in which the work memory 103 is provided in one of the plural data processing apparatuses 100.

According to the embodiments set forth hereinabove, thread-specific data can be migrated to the work memory of the destination processor while the plural processors each having the work memory are each executing plural threads. Since data migration is performed in the background using the DMA, the data migration does not affect the thread processing performance. As a result, the data migration can be efficiently performed with reduced overhead upon the load distribution. This facilitates load distribution enabling the execution times of the thread to be equalized, thereby improving the processing efficiency of the entire system having plural processors and reducing power consumption. In particular, through combination with a general-purpose dynamic voltage frequency scaling (DVFS) control, the power consumption can be expected to be reduced by a large extent.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing method that is executed by a processor, the data processing method comprising:
determining based on a size of an available area of a first memory whether first data of a first thread executed by a first data processing apparatus among a plurality of data processing apparatuses is transferable to a first memory;
transferring second data that is of a second thread and stored in the first memory to second memory, when at the determining, the first data is determined to not be transferrable; and
transferring the first data to the first memory.

2. The data processing method according to claim 1, wherein
the first memory is work memory of one of the data processing apparatuses.

3. The data processing method according to claim 1, wherein
the second memory is memory shared by the data processing apparatuses, and
the transferring includes transferring the second data to the second memory by dynamic memory access transfer.

4. The data processing method according to claim 1, further comprising
starting execution of the second thread after execution of the first thread.

5. The data processing method according to claim 1, further comprising
transferring the first data to the second memory when the size of the first data is greater than the size of the first memory.

6. The data processing method according to claim 1, further comprising
the transferring, when execution of the first thread is interrupted, the first data stored in the first memory to the second memory, transferring third data of a third thread to the first memory, and executing the third thread.

7. The data processing method according to claim 1, further comprising:
selecting from among the data processing apparatuses, two data processing apparatuses having a load difference greater than or equal to a predetermined value; and
migrating at least one thread executed by one of the two data processing apparatuses to the other of the two data processing apparatuses.

8. The data processing method according to claim 7, wherein
the at least one thread is a thread that is executed last in the other data processing apparatus after migration from the one data processing apparatus to the other data processing apparatus.

9. The data processing method according to claim 1, further comprising:
resetting a memory flag of the second thread after transferring the second data to the second memory; and
setting a memory flag of the first thread after transferring the first data to the first memory.

10. A data processing system comprising:
a first memory that is provided for each data processing apparatus;
a second memory that is shared by the data processing apparatuses; and
a memory managing unit that is configured to:
determine based on a size of an available area of the first memory whether first data of a first thread is transferable to the first memory,
transfer second data that is of a second thread and stored in the first memory to the second memory, upon determining the first data to not to be transferable, and
transfer the first data to the first memory.

11. The data processing system according to claim 10, further comprising:
a first bus that is configured to transfer data among the first memories of the data processing apparatuses; and
a second bus that is configured to transfer data between the data processing apparatuses and the second memory.

12. The data processing system according to claim 10, further comprising
a dynamic memory access controller that is configured to transfer the second data to the second memory.

13. The data processing system according to claim 10, wherein
the second memory includes a first memory area and a second memory area, and
the memory managing unit transfers the first data to the first memory area of the second memory, when the size of the first data is greater than the size of the first memory.

14. The data processing system according to claim 10, wherein
the memory managing unit manages for each thread, a flag that indicates whether the first memory is in use, and a flag that indicates whether data of the thread is being transferred between the first memory and the second memory.

15. The data processing system according to claim 10, wherein
the memory managing unit transfers data between the first memory and the second memory in parallel with execution of one of the threads by a first data processing apparatus.
